(19) United States
(12) Patent Application Publication
(10) Pub. No.: US 2026/0257155 A1
(43) Pub. Date: Sep. 3, 2026

(54) Industrial Filter Cloth

(71) Applicant: Valmet Technologies Oy, Espoo (FI)

(72) Inventors: Katja Ojapelto, São João de Ovar (PT); Catarina Marques Fonseca, São João de Ovar (PT); Ana Sofia Murteira, São João de Ovar (PT); Nuno L. Pontes, São João de Ovar (PT)

(73) Assignee: Valmet Technologies Oy, Espoo (FI)

(21) Appl. No.: 19/165,028

(22) PCT Filed: Feb. 16, 2024
(86) PCT No.: PCT/FI2024/050060

§ 371 Date: Sep. 12, 2025

(30) Foreign Application Priority Data
Mar. 16, 2023 (FI) 20235313

(51) Int. Cl. B01D 25/164; B01D 25/176

(52) U.S. Cl. CPC B01D 25/164; B01D 25/176

(57) ABSTRACT

A filter cloth in a press filter, which press filter has filter frames. The filter cloths have integrally formed structure for attachment to the filter frames without tools.

Each filter cloth (10) has opposite side edges (13, 14) and a bottom edge (12). Each filter cloth (10) is configured to cover the operating surfaces of the filter frame and to be attached at least at the side edges (13, 14) of the filter cloth/-s (10). Each filter cloth (10) has at least at one side edge (14) fastening elements (21) and at least at the other side edge (13) counter fastening elements (22) to be fastened to each other and configured to form attachments (20) of the filter cloth (10) to the filter frame and the fastening elements (21) and the counter fastening elements (22) are integrally formed with the filter cloth.

### CROSS REFERENCES TO RELATED APPLICATIONS

This application is a US national phase of PCT/FI2024/050060 filed on Feb. 16, 2024, and claims priority on FI 20235313, filed on Mar. 16, 2023, the disclosures of which are incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to filter cloths for press filters in particular for chamber press filters (also called chamber filter presses) for filtering fluid and solid mixtures.

As known from the prior art, press filters are used especially to separate solids and liquids. For example, the chamber press filter comprises a plurality of adjacent plate-like filter frames configured to be pressed against each other for separating from a slurry or a suspension fed into the chamber press filter solid contents thereof to form filter cakes within the filter chambers. When the plate-like filter frames are moved away from each other and opened the filter cakes can be discharged therefrom. Thereafter filter plates are closed, and further slurry or suspension is fed again into the filter chambers for a subsequent filtration cycle.

It is also known from prior art that each operating surface of the plate-like filter frame is covered with a filter cloth. The filter cloth for one filter frame may be formed of two single filter cloths attached to each other at edges thereof, or of one overhang type of filter cloth, hanging over the top of the filter frame and attached at the edges around the filter frame, or double cloths, connected in one area by commonly known as “barrel neck” and then to be attached around the filter frame.

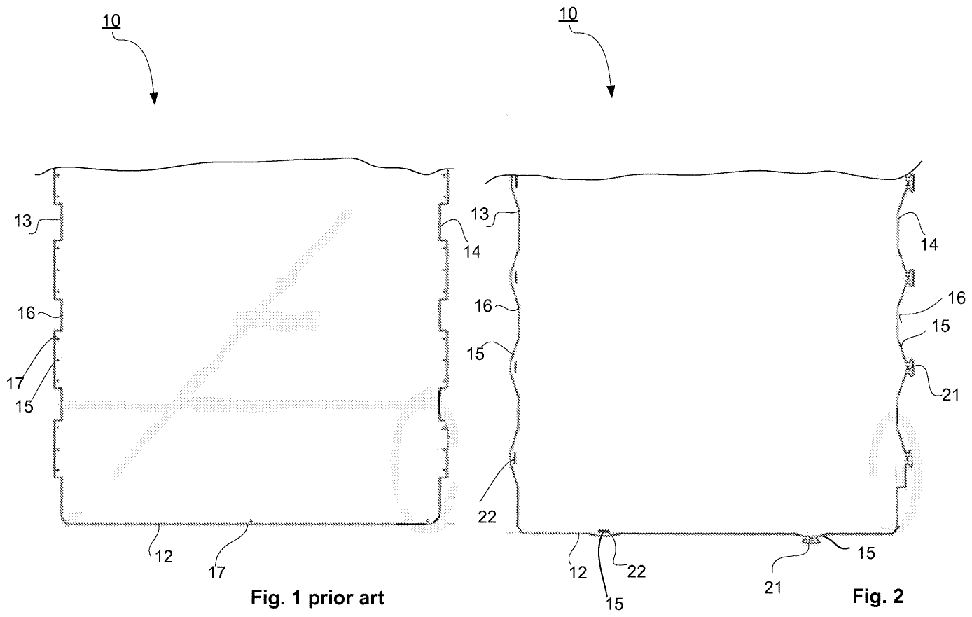

It is known from prior art that different types of the attachment of the edges of the filter cloth for attaching the filter cloth around the filter frame have been made by providing attachment holes at the edge areas of the filter cloth, through which holes plastic cable ties are threaded and fastened to attach the filter cloth to its place. In FIG. 1 is schematically shown an example of a filter cloth 10 known from prior art. The example is a single type filter cloth i.e. two filter cloths 10 are used to cover the filter frame, one on each operating surface of the filter frame. The edges 13, 14 of the filter cloth 10 are provided with tabs 15 spaced apart by recessions 16. The tabs 15 have attachment holes 17. Also, the bottom edge 12 of the filter cloth 10 can have attachment holes 17, respectively. For attachment of the filter cloth several plastic cable ties are thus threaded through the attachment holes 17 of the filter cloth 10 for one operating surface of the filter frame and through respective attachment holes 17 of the respective edge of the filter cloth for the other operating surface of the filter frame and fastened. For example, one chamber press filter may have several thousands of attachment holes and thus several thousands of plastic ties for the filter cloths. The filter cloths of a press filter are typically changed at regular intervals, even every two weeks at the end of the filter cloths' lifetime, the cable ties are cut off with sharp tools causing safety hazard for the operators. The plastic cable ties are thin and difficult to handle, and work is even more difficult as the operators have to wear gloves during the installation. One filter frame may also be several meters high. The fastening procedure is a time-consuming and cumbersome work, bearing in mind also that the filter frames can be several meters high and the filter cloths are replaced with the filter frames in place in the press filter. The cable ties may also fall down and be dragged into the process streams causing damage in the pumps and machinery of the press filter.

An object of the invention is to create a filter cloth, in which the disadvantages and problems of prior art are eliminated or at least minimized.

In particular an object of the invention is to create an improved filter cloth, especially in respect of fastening of the filter cloth around the filter frame of the press filter.

### SUMMARY OF THE INVENTION

According to the invention the filter cloth of a press filter, which press filter comprises filter frames, which filter cloth/-s comprise side edges and a bottom edge and which filter cloth/-s are configured to cover operating surfaces of the filter frame and to be attached at least at side edges of the filter cloth/-s, wherein the filter cloth/-s has/have at least at one side edge fastening elements and at least at the other side edge counter fastening elements to be fastened to each other and configured to form attachments of the filter cloth/-s at the filter frame and the fastening elements and the counter fastening elements are made directly to the filter cloth/-s.

According to an advantageous feature of the invention the fastening elements and the counter fastening elements are made directly to the filter cloth/-s by cutting or punching or other means alike.

According to an advantageous feature of the invention the filter cloth/-s has/have the fastening elements at one side edge of the filter cloth and the counter fastening elements at the other side edge of the filter cloth.

According to an advantageous feature of the invention the fastening element and the counter fastening element are configured to form an inter-lockable, advantageously openable attachment between each other.

According to an advantageous feature of the invention the filter cloth/-s comprise alternating the fastening elements and the counter fastening elements at least at one edge of the filter cloth/-s.

According to an advantageous feature of the invention the bottom and side edges of the filter cloth/-s have tabs spaced apart and the fastening elements and the counter fastening elements are made in connection with the tabs.

According to an advantageous feature of the invention the fastening elements have an inter-lockable shape comprising a stem and arms, for example a T-or an arrow shape.

According to an advantageous feature of the invention the fastening elements have two opposite cuts forming flaps in the stem. The flaps in the stem can advantageously be curved, but they also be formed of other than curved cuts forming correspondingly inter-lockable shape.

According to an advantageous feature of the invention the counter fastening element is a cut, advantageously a straight cut, thus forming a counter shape for the inter-lockable shape of the fastening element. Also, other inter-lockable shapes can be used.

According to an advantageous feature of the invention the length of the cut of the counter fastening elements is equal to or greater than the width of the stem of the fastening element.

According to an advantageous feature of the invention the width between open ends of the arms of the fastening element is equal to or greater than the width of the stem of the fastening element.

According to an advantageous feature of the invention the distance between base parts, i.e. uncut parts of the two flaps formed by the two opposite cuts is equal to or greater than the distance of the cut from the outer edge of the tab of the counter fastening element.

According to an advantageous feature of the invention the filter cloth is a single filter cloth or a double filter cloth or an overhang filter cloth, when covering the filter frame.

According to an advantageous aspect of the invention the filter cloth to be used in a press filter is configured such that, in operation, two pieces of substantially identical filter cloths are used to cover one frame on both operating surfaces, and the edges of the filter cloths are fastened together by the fastening elements on one edge and the counter fastening elements on the other edge.

By the invention and its advantageous features several advantages are achieved: Firstly, the fastening of the filter cloth/-s in place around the filter frame is easy and fast by hand without tools. Secondly, the fastening of the filter cloth/-s in place around the filter frame can be done without any additional accessories, such as cable ties. Thirdly, the removal of used filter cloth/-s from around the filter frame is easy and fast as the attachment is easily openable by hand. Further, each fastening element and the counter element thereof are of the filter cloth material, thus, the recycling properties of the filter cloths and attachment means is improved.

Additionally, there are no loose parts that could end up in the filtration process and thus the damage risks of the press filter are significantly decreased. Also, the filter cloth with the corresponding fastening can be used for single, double and overhang filter cloths.

### BRIEF DESCRIPTION OF THE DRAWINGS

Aspects of the invention, however, together with additional objects and advantages thereof, will be best understood from the following description of some example embodiments when read in connection with the accompanying drawings and in the following the invention is described in more detail referring to the accompanying drawing.

In FIG. 1 is schematically shown an example of a filter cloth known in the prior art.

In FIG. 2 is schematically shown an advantageous example of a filter cloth according to the invention.

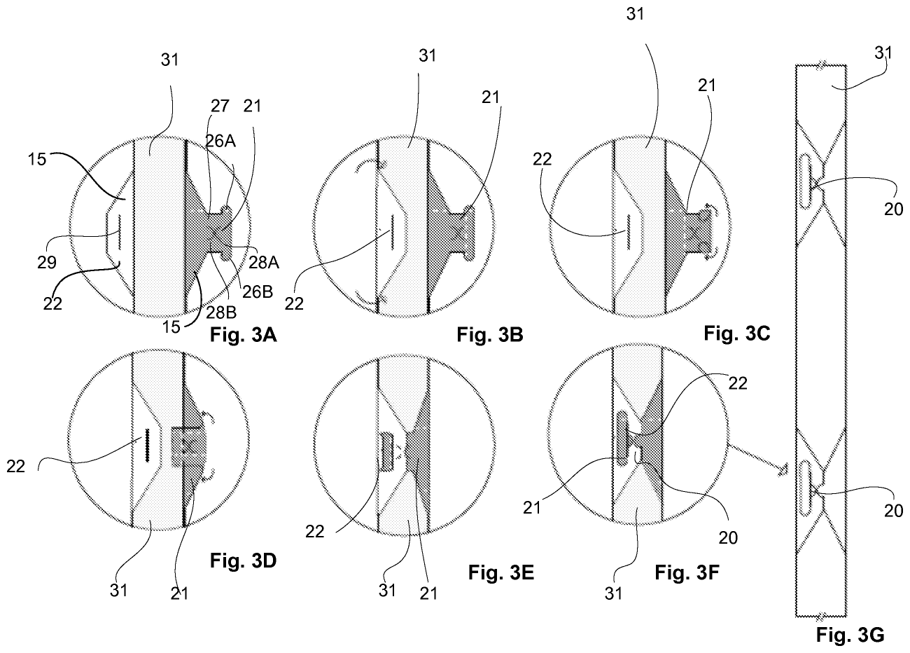

In FIGS. 3A-3G is schematically shown an advantageous example of installing a filter cloth according to the invention around a filter frame.

### DESCRIPTION OF THE PREFERRED EMBODIMENTS

During the course of this description like numbers and signs will be used to identify like elements according to the different views which illustrate the invention. Repetition of some reference signs may have been omitted in the figures for clarity reasons.

In FIG. 1 is schematically shown an example of a filter cloth 10 known from the prior art. The example is a single type filter cloth i.e. two filter cloths 10 are used to cover the filter frame, one on each operating surface of the filter frame. The edges 13, 14 of the filter cloth 10 are provided with tabs 15 spaced apart by recessions 16. The tabs 15 have attachment holes 17. Also, the bottom edge 12 of the filter cloth 10 can have attachment holes 17, respectively. For attachment of the filter cloth several plastic cable ties are thus threaded through the attachment holes 17 of the filter cloth 10 for one operating surface of the filter frame and through respective attachment holes 17 of the respective edge of the filter cloth for the other operating surface of the filter frame and fastened. The configuration of the upper edge of the filter cloth/-s 10 can be any as such to one skilled in the art known configuration.

In FIG. 2 is schematically shown an advantageous example of a filter cloth 10 and in FIGS. 3A-3G is schematically shown an example of installing a filter cloth 10 to a filter frame 31.

The filter frame 31 has a plate-like form and the operating surfaces are the wide sides of the plate-like form, i.e. on opposite sides of the filtering frame 31, and the non-operating surfaces are the narrow sides of the plate-like form i.e. on opposite sides of the filtering frame 31. The filter cloth/-s 10 cover the operating surfaces and the fastening is located on the non-operating surface/-s.

The filter cloth 10 comprises side edges 13, 14 and a bottom edge 12. The side edges 13, 14 comprise tabs 15 spaced apart. The side edges 13, 14 can be straight or comprise recessions 16 between the tabs 15 as shown in the example of the figures. The tabs 15 have advantageously towards the adjacent recessions 16 inclined outlines. The tabs 15 on one of the side edges 14 have outwards extending protrusions each forming a fastening element 21 and the tabs on the other side edge 13 have a counter fastening element 22, to which the respective fastening element 21 is attached for attaching the filter cloth/-s 10 to cover the operating surfaces of the filter frame 31 over the non-operating surface of the filter frame. The tabs 15 provide that the filter cloth/-s 10 extend over the edge of the filter frame 31 forming the fastening distance over the non-operating surfaces, the narrow sides of the filter frame 31.

The filter cloth 10 can be a single filter cloth 10, in the case of which one filter cloth 10 covers one filter surface of the filter frame 31 and the two filter cloths 10 are fastened to each other to cover the operating surfaces of the filter frame 31; a double filter cloth 10, in the case of which the filter cloth 10 is folded around one side edge of the filter frame and the side edges of the filter cloth 10 are fastened to each other to cover the operating surfaces of the filter frame 31; or an overhang filter cloth 10, in which case the filter cloth 10 is folded over the top edge of the filter frame and on each side of the filter frame the side edges of the filter cloth 10 are fastened to each other.

The fastening elements 21 at one side edge 14 and the counter fastening elements 22 at the other side edge 13 are made directly to the filter cloth 10, advantageously by cutting. That is, the fastening elements 21 and the counter fastening elements 22 are integrally formed with the sheets of the filter cloth 10. The fastening element 21 and the counter fastening element 22 are configured to form an interlocking, advantageous attachment 20 between each other.

To the tabs 15 bottom edge 12 of the filter frame the fastening element/-s 21 and the counter fastening elements 22 are advantageously provided alternating such, that also the bottom edge fastening of the filter cloth 10 is provided for the single, double and overhang filter cloths 10.

With such a design according to this invention, the filter cloths can be quickly fastened or detached from the filter frames without bringing any damaging risk. It is known that to some extent vibration exists in the filtration system, in addition to which the filter cakes are sometimes removed manually with special tools, which might also bring a risk of detaching the fastening of the filter cloth.

Therefore, the present invention further attempts to improve the locking stability and reliability of the fastening system on the basis of the foregoing. On this basis, the following advantageous designs are made, and to be described in the context together with the FIGS. 2-3G. This is the technical problem further solved by the present invention, and it is also a sub-inventive point. The technical effects of these further designs are to prevent the detaching of the fastening system, to further secure the locking so that the fastening elements remain stable during filtering process, even during the vibration and movement.

In the advantageous example of the FIGS. 2-3G the fastening element 21 has an inter-lockable shape, and the inter-lockable shape in the example of the figures is formed as a T-shaped form made to the one edge 14 of the filter cloth 10 as a protrusion of the tab 15. The counter fastening element 22 is a cut or slit 29, advantageously a straight cut 29, made in the tab 15 at a distance from the outer edge of the tab 15.

As can be seen from FIG. 3A, the inter-lockable shape, for example the T-shape or an arrow shape, of the fastening element 21 has a stem 27 and two cuts 28A, 28B, advantageously oppositely curved, for example half-circular cuts 28A, 28B, in the stem 27 forming to opposite directions opening flaps. The fastening element 21 further has two opposite direction extending arms 26A, 26B at the outer end of the stem 27. The fastening element 21 is on one side of the filter frame 31 and the counter fastening element 22 is on the other side of the filter frame 31.

To begin the fastening of the filter cloth/-s 10 first the tab 15 of the counter fastening element 22 i.e. the cut 29 and the tab 15 is folded against the non-operating surface of the filter frame 31, as can be seen from FIG. 3B.

In the next stage in the fastening of the filter cloth/-s 10, the arms 26A, 26B of the T-shape of the fastening element 21 are folded to be against the stem 27 of the T-shape of the fastening element 21, as can be seen from FIG. 3C. These fastening elements may be specially treated in order to enhance the wear resistance and to prolong the service life by, for example, coating or other surface treatments.

To proceed further with the fastening of the filter cloth/-s 10, the stem 27 of the T-shape of the fastening element 21 is folded towards the cut 29, i.e. towards the counter fastening element 22, and towards the non-operating surface of the filter frame 31 and the surface of the tab 15, as can be seen from FIG. 3D.

In the following stage, as can be seen from FIG. 3E, the folded arms 26A, 26B and the stem 27 is pushed through the cut 29 such that the flap formed by the cut 28B closer to the base of the stem 27 fastens to the outer edge of the tab 15 of the counter fastening element 22.

As can be seen from FIG. 3F, the folds of the arms 26A, 26B are opened to extend over the length of the cut 29. The flap formed by the other cut 28A fastens to the edge of the cut 29 such, that the flaps formed by the cuts 28A, 28B are the cut parts opposite to each other on the tab 15 of the counter fastening element 22 and attachment 20 of the fastening element 21 and the counter fastening element 22 is provided and thus, the edges 13, 14 of the filter cloth/-s 10 are fastened to each other on the non-operating surface of the filter frame 31, as can be seen also from FIG. 3G.

The length of the cut 29 of the counter fastening elements 22 is equal to or greater than the width of the stem 27 of the T-shape of the fastening element 21 such that the stem 27 fits through the cut 29. The width between the open ends of the arms 26A, 26B of the T-shape of the fastening element 21 is greater than the width of the stem 27 of the T-shape of the fastening element 21 and the length of the cut 29 of the counter fastening elements 22. The distance between the base parts, i.e. uncut parts of the two flaps formed by the two cuts 28A, 28B is equal to or greater than the distance of the cut 29 from the outer edge of the tab 15 of the counter fastening element 22, thus providing a secure and tight fastening of the filter cloth/-S.

In the description in the foregoing, although some functions have been described with reference to certain features, those functions may be performable by other features whether described or not. Although features have been described with reference to certain embodiments or examples, those features may also be present in other embodiments or examples whether described or not. Above the invention has been described by referring to some advantageous examples only to which the invention is not to be narrowly limited. Many modifications and alterations are possible within the invention as defined in the following claims.

1-12. (canceled)

13. A filter cloth/-s for a press filter, which press filter having filter frames, the filter cloth/-s comprising: side edges and a bottom edge and which filter cloth/-s are configured to cover operating surfaces of the filter frame and to be attached at least at side edges of the filter cloth/-s, wherein the filter cloth/-s has/have at least at one side edge fastening elements and at least at another side edge counter fastening elements to be fastened to each other and configured to form attachments of the filter cloth/-s at the filter frame and that the fastening elements and the counter fastening elements are integrally formed with the filter cloth/-s.

14. The filter cloth of claim 13 wherein the fastening elements and the counter fastening elements are made directly to the filter cloth/-s by cutting or punching.

15. The filter cloth of claim 13 wherein the filter cloth/-s has/have the fastening elements at one side edge of the filter cloth and the counter fastening elements at the other side edge of the filter cloth.

16. The filter cloth of claim 13 wherein the filter cloth/-s comprise alternating the fastening elements and the counter fastening elements at least at one edge of the filter cloth/-s.

17. The filter cloth of claim 13 wherein the fastening element and the counter fastening element are configured to form an inter-lockable and openable attachment between each other.

18. The filter cloth of claim 13 wherein the bottom and side edges of the filter cloth/-s have tabs spaced apart and that the fastening elements and the counter fastening elements are made in connection with the tabs.

19. The filter cloth of claim 13 wherein the fastening elements have an inter-lockable shape comprising a stem and with arms extending from the stem, the distance between outer edges of the arms being greater than the width of the stem.

20. The filter cloth of claim 19 wherein the fastening elements have two opposite cuts forming flaps in the stem, each flap extending from an uncut base part of the stem, the flaps being spaced a flap distance apart measured from where the flaps join the uncut base part.

21. The filter cloth of claim 20 wherein the flap distance is equal to or greater than a distance of the straight cut from an outer edge of the tab of the counter fastening element.

22. The filter cloth of claim 13 wherein the counter fastening element comprises a tab with a straight cut positioned on the tab spaced a cut distance from an outer edge of the tab, and wherein the fastening element has a tab with a stem extending therefrom, and wherein a length of the counter fastening element straight cut is equal to or greater than a width of the fastening element stem.

23. A filter cloth for a filter frame of a press filter having an operating surface, the filter cloth comprising:
a rectangular filter segment having a first side edge and a second side edge opposite the first side edge, and a bottom edge extending between the first side edge and the second side edge;
at least one fastening element extending from the first side edge;
at least one counter fastening element extending from the second side edge; and
wherein the at least one fastening element is configured to be fastened to the counter fastening element of the filter cloth or to a like counter fastening element of a like filter cloth, wherein each of the at least one fastening element and the at least one counter fastening element is integrally formed together with the rectangular filter segment or a rectangular filter segment of the like filter cloth.

24. The filter cloth of claim 23 wherein the at least one fastening element extends from the first side edge of the rectangular filter segment and the at least one counter fastening element extends from the second side edge of the filter cloth.

25. The filter cloth of claim 23 wherein tabs project from the bottom edge, the first side edge and the second side edge of the rectangular filter segment, and wherein the at least one fastening element and the at least one counter fastening element each extend from one of the tabs.

26. The filter cloth of claim 23 wherein the at least one fastening element de-fines an inter-lockable shape comprising a stem and protruding arms.

27. The filter cloth of claim 26 wherein the at least one fastening element stem has portions defining two cuts which cross to define two flaps which extend from uncut base parts of the stem.

28. The filter cloth of claim 23 wherein the at least one counter fastening element comprises a straight slit in a projecting tab.

29. The filter cloth of claim 28 wherein the at least one fastening element defines an inter-lockable shape comprising a stem having a stem width and arms which extend from the stem, and wherein a length of the straight slit in the at least one counter fastening element is equal to or greater than the stem width of the fastening element.

30. The filter cloth of claim 27 wherein the at least one counter fastening element comprises a straight slit in a projecting tab, the straight slit being positioned a first distance from an outer edge of the counter fastening element, and wherein a second distance between the two uncut base parts is equal to or greater than the first distance of the slit cut from the outer edge of the tab of the counter fastening element.

31. A filter cloth assembly for a filter frame of a press filter having an operating surface, the filter cloth comprising:
a rectangular front filter segment having a first side edge and a second side edge opposite the first side edge;
a rectangular rear filter segment having a first side edge and a second side edge opposite the first side edge;
a fastening element extending from the rectangular front filter segment first side edge;
a counter fastening element extending from the rectangular rear filter segment second side edge and engaged with the fastening element;
wherein the fastening element comprises a first tab which extends in a first direction from the front filter segment first side edge, and wherein a stem projects in the first direction from the first tab and wherein two arms extend from the stem in a second direction which is perpendicular to the first direction, and wherein two crossing slits in the stem define an inner flap and an outer flap spaced outwardly in the first direction from the inner flap, the inner flap extending from a base part which is not cut by the two crossing slits, and the outer flap extending from the base part at a flap distance from where the inner flap extends from the base part; and
wherein the counter fastening element comprises a second tab which extends in the first direction towards the first tab, and portions of the second tab define a capture slit extending perpendicular to the first direction, the capture slit being spaced in the first direction from an outer edge of the second tab a distance which is equal to or greater than the flap distance, and wherein the two arms of the fastening element extend through the counter fastening element capture slit and portions of the fastening element first flap and second flap overlie the counter fastening element second tab thereby fastening the fastening element to the counter fastening element.
